(19) United States
(12) Patent Application Publication
(10) Pub. No.: US 2009/0088510 A1
(43) Pub. Date: Apr. 2, 2009

(54) Thermoplastic polyolefin material with high surface gloss

(75) Inventors: Frank E. Jones, III, Nashville, TN (US); Jason Fincher, Nashville, TN (US)

Correspondence Address: BUCHANAN, INGERSOLL & ROONEY PC, POST OFFICE BOX 1404, ALEXANDRIA, VA, 22313-1404, US

(73) Assignee: ADVANCED COMPOSITES, INC., Sidney, OH (US)

(21) Appl. No.: 11/905,301

(22) Filed: Sep. 28, 2007

(51) Int. Cl. C08L 23/12; C08K 3/10; C08K 3/34

(52) U.S. Cl. 524/426; 524/445; 524/449; 524/451; 524/575; 524/584

(57) ABSTRACT

A compound is described including one or more polymer (A) selected from propylene-ethylene block copolymers (A1), propylene homopolymers (A2) and a combination of copolymers (A1) and/or homopolymers (A2), at 30% to 90% by weight; one or more copolymer (B) selected from ethylene-alpha-olefin random copolymers (B1), hydrogenated styrene-ethylene-butadiene-styrene block copolymers (B2) and a combination of two or more of copolymers (B1) and/or copolymers (B2), at 0% to 50% by weight; one or more mineral filler (C) at 0% to 30% by weight; one or more surface modifier (D) at 0% to 5% by weight; one or more additive (E) at 0% to 5% by weight; and one or more colorant (F) at 0% to 10% by weight. Associated articles and methods are also described.

### FIELD

The present invention relates to thermoplastic polypropylene compounds, especially thermoplastic polypropylene compounds that provide high surface gloss when injection molded into a highly polished mold.

### BACKGROUND

In the discussion that follows, reference is made to certain structures and/or methods. However, the following references should not be construed as an admission that these structures and/or methods constitute prior art. Applicant expressly reserves the right to demonstrate that such structures and/or methods do not qualify as prior art.

The class of compounds known as thermoplastic polyolefins (TPO) is generally composed of materials with a majority percentage of polypropylene homopolymers or block copolymers melt blended with mineral fillers and/or elastomeric polymers. These modifiers enable performance far outside the capability of reactor grade polypropylenes. TPO compounds are commonly used in the automotive industry for a variety of applications due to their attractive balance of performance and cost.

In many cases TPO compounds are painted; however, TPO compounds can be integrally pigmented to give a desired color without painting. These TPO compounds are commonly known as Mold-in-Color (MIC) TPO. The ability of MIC TPO to eliminate paint and the painting process has given automotive manufactures an option to reduce cost without sacrificing overall part quality. This is particularly true for interior automotive applications such as instrument panels and interior trim. MIC TPO compounds are modified with compatibilizers and/or lubricants to improve the durability and scratch resistance of the base TPO compounds. Descriptive of these particular compounds is U.S. Pat. No. 6,300,419.

The use of MIC TPO for exterior applications has been limited to a small number of applications due to the inability of previous TPO compounds to meet the stringent requirements for many exterior painted articles including high surface gloss, durability, and characteristic physical properties at an attractive cost. Although not in wide use, several patents have been granted in recent years for high gloss TPO compounds. Descriptive of these inventions are U.S. Pat. Nos. 6,048,942, 6,017,989 and 6,753,373. These compounds generally rely on technology that is not cost effective or cannot meet the stringent requirements of most exterior automotive applications. Thus, these materials have not received wide acceptance in the automotive industry.

Another difficulty involved in exterior MIC TPO applications is the design challenges introduced by metallic flake necessary to match exterior paint. Metallic flake induces flow instabilities that cause visual defects during molding. U.S. Pat. No. 6,646,038 describes a color concentrate that decreases these effects; however, a TPO with inherent flow stabilization is desirable. Metallic flake also acts as a contaminant that has deleterious effects on physical properties, particularly impact performance.

The present invention provides MIC TPO compounds that are cost-effective solutions for high gloss exterior automotive applications. In addition, the materials have inherent properties that minimize the effect of metallic flake on flow instabilities. The materials also have physical properties that satisfy automotive requirements when integrally pigmented with both pigments and metallic flake.

### SUMMARY

According to certain aspects, the present invention provides thermoplastic polypropylene compounds and related methods which may address one or more of the deficiencies noted above in connection with conventional TPO compounds.

The present invention also relates to thermoplastic polypropylene compounds and thermoplastic polyolefin compounds that provide high surface gloss when injection molded into a highly polished mold. These compounds can be integrally pigmented to closely match painted articles. Of these compounds, integrally pigmented materials that meet the stringent requirements of automotive exterior applications such as trim or bumper fascias are useful; however, the uses of the present invention are not limited to exterior trim and bumper fascias or automotive applications in general.

The compounds of the present invention can comprise at least one polymer (A) selected from the group comprising, consisting essentially of, or consisting of propylene-ethylene block copolymers (A1), propylene homopolymers (A2) and a combination of copolymers (A1) and/or homopolymers (A2), at 30% to 90% by weight; at least one copolymer (B) selected from the group comprising, consisting essentially of, or consisting of ethylene-alpha-olefin random copolymers (B1), hydrogenated styrene-ethylene-butadiene-styrene block copolymers (B2) and a combination of copolymers (B1) and/or copolymers (B2), at 0% to 50% by weight; at least one filler selected from the group comprising, consisting essentially of, or consisting of at least one mineral filler (C) and a combination of two or more of fillers (C), at 0% to 30% by weight; at least one surface modifier (D) at 0% to 5% by weight; at least one additive (E) at 0% to 5% by weight; and at least one colorant (F) at 0% to 10% by weight.

According to further aspects, the present invention provides a body formed from a compound of the type described above.

According to yet another aspect, the present invention provides a part of an automobile formed from a compound of the type described above.

According to still another aspect of the present invention, a method for forming a molded body is provided which includes: melt blending the constituents (A), (B), (C), (D) and (E) of the compound described above; pelletizing the melt blend to form a plurality of pellets; and injection molding the pelletized blend.

### DETAILED DESCRIPTION

According to certain aspects, the present invention provides a family of thermoplastic polyolefin compounds capable of producing a high surface gloss when molded appropriately in a highly polished mold. The most common way of quantifying gloss is to use a device that measures the final intensity of light reflected from a surface at a small range of reflectance angles comparable to the original angle of incidence of a light source. The device then reports the measured intensity relative to the intensity of light reflected off of a standard reference material. Generally, “high gloss” is classified as gloss greater than 70 using a 20° angle of incidence. For MIC TPO, a 60° angle of incidence is generally used for MIC TPO in the automotive industry. The term “high surface gloss” generally means a 60° gloss of greater than 76 for exterior automotive applications. A micro-gloss 60° meter from BYK Gardner is useful for measuring 60° gloss value.

The compounds of the present invention may comprise at least one polymer (A) selected from the group comprising, consisting essentially of, or consisting of propylene-ethylene block copolymers (A1), propylene homopolymers (A2) and a combination of copolymers (A1) and/or homopolymers (A2) at 30% to 90% by weight; at least one copolymer (B) selected from the group comprising, consisting essentially of, or consisting of ethylene-alpha-olefin random copolymers (B1), hydrogenated styrene-ethylene-butadiene-styrene block copolymers (B2) and a combination of copolymers (B1) and/or copolymers (B2) at 0 to 50% by weight; at least one filler selected from the group comprising, consisting essentially of, or consisting of mineral fillers (C) and a combination of two or more of fillers (C), at 0% to 30% by weight; at least one surface modifier (D) at 0% to 5% by weight; at least one additive (E) at 0% to 5% by weight; and at least one colorant (F), with or without metallic flake, at 0% to 10% by weight.

These constituents listed above can be melt compounded in twin-screw extruders, high-intensity continuous mixers, Banbury mixers, and the like. Used at the appropriate ratios, these constituents can be used to produce compounds that meet automotive requirements for high surface gloss while satisfying requirements for durability and physical properties.

The total amount of propylene-ethylene block copolymer(s) (A1) and/or propylene homopolymers (A2) are 30% to 90%, alternatively 45% to 80%, alternatively 60% to 70% by weight of the final compound.

Possible melt flow rates of the propylene-ethylene block copolymers (A1) used in this invention are 0.7 to 200 g/10 min, more particularly 35 to 110 g/10 mm at 230° C. and 2.16 kg according to ASTM D-1238. The propylene-ethylene blocks can make up less than 30% by weight, alternatively 5 to 14%, most particularly 7 to 10% of polymers (A).

Particular propylene-ethylene block copolymers (A1) of the present invention may be provided with high crystallinity polypropylene blocks and high intrinsic viscosity ethylene-propylene blocks to stabilize flow during injection molding. “High crystallinity” refers to polypropylene with a % mesopentad greater than 97% mmmm determined by high field NMR. “High intrinsic viscosity” refers to ethylene propylene blocks whose intrinsic viscosity is greater than 6 dl/g when measured in decahydronaphthalene at 135° C.

The high crystallinity propylene blocks can make up greater than 90% of the overall polymer (A1), alternatively greater than 92% by weight. The high intrinsic viscosity ethylene-propylene blocks can make up less than 10%, alternatively 5 to 8% of the overall polymer (A1). Although unnecessary for many applications, copolymers (A1) with ethylene-propylene blocks with intrinsic viscosity of 6 to 12 dl/g can be useful. The melt flow rates at 230° C. and 2.16 kg for these polymers may vary from 6 to 120 g/10 min according to ASTM D-1238. Descriptive of these materials is U.S. Pat. No. 6,537,942.

The melt flow rates of propylene homopolymer(s) (A2) used in this invention can be <1 to 400 g/10 min, more particularly 0.7 to 400 g/10 min, and even more particularly 35 to 120 g/10 min at 230° C. and 2.16 kg according to ASTM D-1238. Although propylene homopolymers of any crystallinity may be used in general, propylene homopolymers that are highly crystalline in nature may be of particular use. The xylene soluble portion can make up less than 1.5% by weight, more particularly less than 1.0% of polymers. Representative examples of these materials are F1000HC and F350HC2 from Sunoco.

The at least one copolymer (B) contains ethylene-alpha-olefin random copolymers (B1) and/or hydrogenated styrene-ethylene-butadiene-styrene block copolymer (B2). The copolymer (B) can be hydrogenated styrene-ethylene-butadiene-styrene block copolymer (B2) or a combination of two or more of copolymer (B1) and copolymer (B2) to impart needed material toughness. Two or more hydrogenated styrene-ethylene-butadiene-styrene block copolymers (B2) may also be included in the preset invention

The total amount of ethylene-alpha-olefin random copolymers (B1) and/or hydrogenated styrene-ethylene-butadiene-styrene block copolymers (B2) can be 0% to 50%, particularly 0% to 40%, more particularly 15 to 35%, and even more particularly 20 to 30% by weight of the final compound. The amount of copolymer (B2) can be 1% to 40%, more particularly 5 to 15% by weight of the final compound.

The ethylene-alpha olefin random copolymers (B1) may comprise copolymers made of ethylene subunits and alpha-olefin subunits having 3 to 10 carbons. The ethylene-alpha olefin random copolymers (B1) may be exemplified by ethylene-propylene random copolymers, ethylene-butene random copolymers, and ethylene-octene random copolymers. Density of the copolymers (B1) is can be 0.86 to 0.91 g/cm³ and the melt index of the copolymers (B1) can be 0.1 to 30 g/10 min, more particularly 13 to 30 g/10 min at 2.16 kg and 190° C. according to ASTM D-1238. Representative of these materials are Engage Polyolefin Elastomers from Dow, Exact Polyolefin Elastomers from Exxon, and Tafmer Polyolefin Elastomers from Mitsui Chemicals.

Ethylene-octene random copolymers with a DSC melting temperature above the required operating and testing temperatures for a particular application may be utilized in accordance with the principles of the present invention. For exterior automotive applications, DSC melting peaks of the ethylene-octane random copolymers can be greater than 70° C., more in their particularly greater than 90° C.

The styrene/ethylene-butadiene ratios of copolymers (B1) can be 12/88 to 67/33 according to Asahi Kasei's method, more particularly 12/88 to 20/80 with melt flow rates of 0.8 to 150 g/10 min, more particularly 4.5 to 13 g/10 min at 230° C. and 2.16 kg according to ASTM D-1238. Representative of these materials are Tuftec H elastomers from Asahi Kasei and Kraton G SEBS from Kraton.

The at least one mineral filler (C) that may be used in this invention are exemplified by calcium carbonate, talc, wollastonite, mica, nanoclay and mixtures thereof. The total mineral filler content of this invention can be 0% to 30%, more particularly 5% to 15% by weight. For use in this invention, the median particle size of the mineral fillers (C) is can be less than 2 μm, more particularly less than 1 μm.

According to one aspect of the present invention, combinations of talc fillers with median particle size less than 1 micron, more particularly less than 0.5 μm, and separate talc fillers with median particle size greater than 1 μm and less than 2 μm may be provided. The talc fillers with median particle size less than 1 μm provide physical property benefits without significantly decreasing surface gloss. The talc fillers with median particle sizes greater than 1 micron and less than 2 μm provide property benefits along with increased resistance to mar but at the cost of a greater decrease in gloss than smaller minerals of the same type. The 1 to 2 μm median particle size talc may be present in the composition at 1 to 10%, more particularly at 5 to 7%. The talc with median particle size less than 1 μm may be provided at 1 to 20%, more particularly 5 to 15%. The synergy between these two sizes of talc fillers may be very useful in certain embodiments of this invention.

The at least one surface modifier (D) used in this invention may be included at a total content of less than 5% by weight, more particularly 0.05 to 1.00% by weight, and even more particularly 0.1 to 0.5% by weight. Modifiers useful in this invention include but are not limited to quaternary ammonium, phosphonium, or sulfonium salts; sodium salts of sulfonates, phosphates, and carboxylic acids; glycerol esters of fatty acids; fatty acid esters; ethoxylated tertiary amines; fatty amides; fatty acid amides; natural and manufactured waxes; metallic salts of fatty acids; silica compounds; polyvinyl alcohol; polyamides; polyethylene; and polysiloxanes. Either one or a combination of surface modifiers is used depending on the application.

At least one additive (E) may be incorporated into compositions formed according to the principles of the present invention. The types of additives useful in this invention include but are not limited to primary anti-oxidants, secondary anti-oxidants, light stabilizers, and/or processing aids. The total additive content from this group may be less than 5% by weight, particularly 0.1 to 3.0%, more particularly 0.5 to 1.0% by weight of the final product.

The first additives of use are primary antioxidants. The primary antioxidants include but are not limited to molecules belonging to the families of secondary aromatic amines, hindered phenolics and hydroxylamines. The thermoplastic-polyolefin compound of the invention can contain either one or a combination of two or more primary antioxidants.

A second type of additive that can be incorporated into the invention is a secondary antioxidant. The secondary antioxidants include but are not limited to molecules belonging to the families of phopshites, thioesters, and hydroxylamines. The thermoplastic-polyolefin compound of the invention can contain one or a combination of more than one secondary antioxidant.

A third type of additive that can be incorporated into this invention is a light and/or ultraviolet (UV) light stabilizer. The UV/light stabilizers include but are not limited to molecules belonging to the families of benzophenones, benzotriazoles, phenyl esters, aryl esters, formamidines, oxanilides, acrylic esters, organic nickel complexes, hindered amines, triazines, hindered benzoates, benzoxazinones, and hydroxyphenyl triazines. The thermoplastic-polyolefin compound of the invention can contain one or a combination of two or more of these light stabilizers.

A fourth type of additive that can be incorporated into the invention is a processing aid. The processing aids include but are not limited to metal soaps, metal stearates, hydrocarbon waxes, polyethylenes, amide waxes, fatty acids, fatty alcohols, and esters. One or more of these processing aids can be used in the thermoplastic-polyolefin compound of the invention.

At least one colorant (F) can be included in compositions formed according to the present invention at, for example, 0 to 10% by weight, particularly 0.5 to 6.0%, more particularly 0.75 to 2.0% by weight. The colorants can be added either as individual components or in a pre-dispersed master-batch with polyolefin carrier. These colorants include but are not limited to organic and inorganic pigments, with or without metallic flakes. The inorganic pigments that can be incorporated into this invention include but are not limited to carbon blacks; titanium dioxide; iron oxide yellows, tans, reds, and blacks; chromium oxide greens; lead chromate yellows; chrome oranges; lead molybdate oranges; cadmium yellows, oranges, reds, and maroons; mercury cadmium oranges, reds, and maroons; ultramarine blues, violets, and pinks; iron blues; complex inorganic pigments; zinc sulfides; and zinc oxides. The organic pigments that can be incorporated into this invention include but are not limited to diarylide yellows and oranges; hansa yellows; nickel azo yellows; benzimidazolone yellows, oranges, and reds; isoindolinone and isoindoline yellows, oranges, and reds; vat yellows and oranges; flavanthrone yellows; disazo condensation yellows and reds; quinacridone reds, magentas, and violets; thioindigoid reds and violets; diketo-pyrrolo-pyrrol reds and oranges; dianisidine oranges; dinitraniline oranges, naphthol reds; red lake C; permanent Red 2B; pigment scarlet; alizarine maroons; carbazole dioxazine violets; indanthrone blues; phthalocyanine blues; and phthalocyanine greens. Finally, the metallic flake which may be used in this invention includes but is not limited to aluminum, copper, zinc, and their alloys.

When combined at the correct ratios, the components above can be used to produce materials with the high gloss, physical properties, and durability required for exterior automotive applications. A 60° gloss of greater than 85% with gloss retention after mar according to an automotive OEM test method of greater than 90% is readily achievable using a variety of the combinations specified above.

### EXAMPLES

The following illustrative, non-limiting examples describe particular embodiments of the invention disclosed. The material combinations described below are melt-blended and pelletized. The properties of the individual formulations are determined both from pellets and injection molded samples.

### Preparation

Before melt blending, the specified components are dry-blended at room temperature. The blended materials are fed at a set rate into a co-rotating twin screw extruder via a screw feeding system. The materials are blended in the extruder with processing temperatures between 160 and 220° C. The molten material is separated into molten strands at the die face of the extruder. The strands are cooled in a water bath followed by pelletization in a pelletizer.

A variety of raw materials were used to produce these final materials. Raw material designations and descriptions for the examples are as follows:
1. CPP1—polypropylene-ethylene block copolymer with approximately 93% high crystallinity polypropylene blocks, approximately 7% high intrinsic viscosity ethylene-propylene rubber by weight, medium to low gel count, and a nominal melt flow rate of 40 g/10 min at 230° C./2.16 kg according to ASTM D-1238. The total ethylene content of the copolymer is approximately 3%.
2. CPP2—polypropylene-ethylene block copolymer with approximately 93% high crystallinity polypropylene blocks, approximately 7% high intrinsic viscosity ethylene-propylene rubber by weight, medium to low gel count, and a nominal melt flow rate of 55 g/10 min at 230° C./2.16 kg according to ASTM D-1238. The total ethylene content of the copolymer is approximately 3%.
3. CPP3—general purpose polypropylene-ethylene block copolymer with approximately 14% ethylene-propylene rubber by weight and a nominal melt flow rate of 115 g/10 min at 230° C./2.16 kg according to ASTM D-1238. The total ethylene content of the copolymer is approximately 8%.
4. HPP1—general purpose polypropylene homopolymer with a nominal melt flow rate of 12 g/10 min at 230° C./2.16 kg according to ASTM D-1238.
5. HPP2—high crystallinity polypropylene homopolymer with a nominal melt flow rate of 35 g/10 min at 230° C./2.16 kg according to ASTM D-1238.
6. HPP3—high crystallinity polypropylene homopolymer with a nominal melt flow rate of 115 g/10 min at 230° C./2.16 kg according to ASTM D-1238.
7. EOR1—ethylene-octene random copolymer with a density of 0.864 g/cm³ according to ASTM D-792, a melt index of 13 g/10 min at 190° C./2.16 kg according to ASTM D-1238, and DSC melting peak at 10° C./min of 50° C.
8. EOR2—ethylene-octene random copolymer with a density of 0.902 g/cm³ according to ASTM D-792, a melt index of 30 g/10 min at 190° C./2.16 kg according to ASTM D-1238, and DSC melting peak at 10° C./min of 98° C.
9. EOR3—ethylene-octene random copolymer with a density of 0.87 g/cm³ according to ASTM D-792, a melt index of 5 g/10 min at 190° C./2.16 kg according to ASTM D-1238, and DSC melting peak at 10° C./min of 60° C.
10. EBR1—ethylene-butene random copolymer with a density of 0.864 g/cm³ according to ASTM D-792 and a melt index of 3.6 g/10 min at 190° C./2.16 kg according to ASTM D-1238
11. SEBS1—hydrogenated styrene-ethylene-butadiene-styrene copolymer with a density of 0.89 g/cm³ according to ASTM D-792, a melt flow rate of 4.5 g/10 min at 230° C./2.16 kg according to ASTM D-1238, and an S/EB ratio of 18/82.
12. TALC1—talc mineral filler with a median particle diameter of 0.7 μm and top size of 4 μm.
13. TALC2—talc mineral filler with a median particle diameter of 1.9 micron and top size of 8 μm.
14. TALC3—talc mineral filler with a median particle diameter of 0.21 micron and top size less than 1.0 μm.
15. ADD1—additive combination with 20% erucamide, 20% Atmul 918K from American Ingredients Company, 20% B225 from Ciba Specialty Chemicals, 30% LA-52 MP from Amfine Chemical Corporation, and 10% magnesium-stearate.
16. ADD2—additive combination with 15.4% erucamide, 15.4% Atmul 918K from American Ingredients Company, 15.4% B225 from Ciba Specialty Chemicals, 15.4% THT-7001 from Cytec Industries, 30.7% UV3853S from Cytec Industries, and 7.7% magnesium-stearate.
17. COLOR1—30% carbon black in polyethylene carrier.
18. COLOR2—metallic flake and pigments in polyethylene carrier that gives a high chroma gold metallic color known as Pueblo Gold in finished product supplied by Americhem.
19. COLOR3—metallic flake and pigments in polyethylene carrier that gives a high chroma gray metallic color in finished product known as Dark Shadow Gray supplied by Americhem.

### Evaluation

The materials are injection molded into ISO test pieces, 100 mm×100 mm×3 mm instrumented impact plaques, or 445 mm×110 mm×3 mm high gloss plaques for surface analysis or weathering. The materials are characterized by one or more of the following tests:
1. MFR—Melt flow rate at 230° C. and 2.16 kg according to ISO 1133 (g/10 min)
2. TS—Tensile strength at yield according to ISO 527 (MPa)
3. FM—Flexural modulus according to ISO 178 (MPa)
4. RTNI—Notched Izod impact at 23° C. according to ISO 180-A (kJ/m²)
5. CTNI—Notched Izod impact at −40° C. according to ISO 180-A (kJ/m²)
6. II—Instrumented impact at −30° C. and 2.2 m/s according to ASTM D3762 (% ductile)
7. TIG—Tiger striping appearance, internal rating, (5=best, 1=worst)
8. GL—60° Gloss of injection molded sample in a high polish mold (−)
9. GRM—Gloss retention after mar according to FLTM-BI 161-01 with 60° gloss (%)
10. HAGL—600 Gloss after heat age at 90° C. for 24 hrs (−)
11. DE—Delta E after accelerated weathering according to SAE J1976 for X hours (−)
12. WEGL—60° Gloss after accelerated weathering according to SAE J1976 for X hours (−)

### Example 1

Three exemplary compositions were prepared and formulated as set forth in Table 1A. The primary difference between these three example materials is elastomer characteristics. The properties of these exemplary formulations are summarized in Table 1B. Of particular interest is variation in DSC melting temperature of the elastomers. The DSC melting temperature of EOR1 is 50° C. while the DSC melting temperature of EOR2 is 98° C. SEBS1 has no discernable DSC melting temperature.

This example clearly shows the superior gloss retention after heat age of a compound with an ethylene-octene random copolymer (EOR) or hydrogenated styrene-ethylene-butadiene styrene elastomer with DSC melting peak higher than the operating temperature relative to a compound with an EOR with DSC melting peak lower than the operating temperature. The gloss of EX1-A with EOR1 dropped from 83 to approximately 15 after heat age at 90° C. for 168 hrs. Both EX1-B with hydrogenated SEBS and EX1-C with EOR2 maintained near 100% of their original gloss under the same conditions.

TABLE 1A
Composition of Materials Included in Example 1

| | Component Ratios for | | |
|---|---|---|---|
| | Example 1 Materials | | |
| Component | EX1-A | EX1-B | EX1-C |
| CPP1 | 65 | 5 | 65 |
| CPP2 | | 60 | |
| EOR1 | 25 | | |
| EOR2 | | | 25 |
| SEBS1 | 5 | 30 | 5 |
| TALC1 | 5 | 5 | 5 |
| ADD1 | 1 | 1 | 1 |
| COLOR1 | 2 | 2 | 2 |

TABLE 1B
Properties of Example 1 Materials

| | Properties of | | |
|---|---|---|---|
| | Example 1 Materials | | |
| Physical Property | EX1-A | EX1-B | EX1-C |
| MFR | 27.4 | 23.9 | 30.0 |
| TS | 19.3 | 20.7 | 22.2 |
| FM | 1136 | 1119 | 1245 |
| RTNI | 50.9 | 63.0 | 39.8 |
| CTNI | 7.1 | 14.1 | 3.7 |
| II | 100 | 100 | 100 |
| GL | 83 | 83 | 83 |
| HAGL | 16 | 80 | 83 |

### Example 2

Two exemplary formulations, EX2-A and EX2-B, as set forth in Table 2A, are different colors of the same base material. These materials have high gloss and excellent gloss retention after mar. In addition, tiger striping due to flow instabilities was undetectable during analysis of these materials that contain metallic flake. The physical properties of these materials, which are summarized in Table 2B, also meet automotive requirements for exterior applications such as rocker panels, trim, and bumper fascias.

TABLE 2A
Composition of Materials Included in Example 2

Component Ratios for
Example 2 Materials

| Component | EX2-A | EX2-B |
|---|---|---|
| CPP1 | 48 | 48 |
| CPP2 | 20 | 20 |
| EOR2 | 20 | 20 |
| SEBS1 | 10 | 10 |
| TALC2 | 6 | 6 |
| ADD2 | 1.3 | 1.3 |
| COLOR2 | 4 | |
| COLOR3 | | 4 |

TABLE 2B
Properties of Example 2 Materials

Physical Properties for
Example 2 Materials

| Property | EX2-A | EX2-B |
|---|---|---|
| MFR | 28.7 | 28.4 |
| TS | 20.1 | 20.0 |
| FM | 1127 | 1122 |
| RTNI | 44.0 | 41.2 |
| CTNI | 4.4 | 4.0 |
| II | 100 | 100 |
| TIG | 5 | 5 |
| GL | 84.7 | 80.0 |
| GRM | 95.6 | 97.4 |

### Example 3

Six additional material formulations were prepared, as set forth in Table 3A. This example demonstrates the synergistic effect of talc fillers with different particle sizes. TALC1 has a median particle size of 0.7 micron. TALC2 has a median particle size of 2 micron. TALC1 has less effect on initial gloss than TALC2 while imparting similar property benefits in general. TALC2 imparts additional mar resistance that translates into higher gloss after mar. Depending on the application, a combination of these two talc fillers can be used to improve mar resistance with a minimal effect on initial gloss. EX3-B, EX3-C, EX3-D, and EX3-E are examples of this effect. Various properties of these exemplary material compositions are summarized in Table 3B.

TABLE 3A
Composition of Materials Included in Example 3

| | Component Ratios for Example 3 Materials | | | | | |
|---|---|---|---|---|---|---|
| Component | EX3-A | EX3-B | EX3-C | EX3-D | EX3-E | EX3-F |
| CPP1 | 65 | 65 | 65 | 65 | 65 | 65 |
| EOR1 | 25 | 25 | 25 | 25 | 25 | 25 |
| SEBS1 | 5 | 5 | 5 | 5 | 5 | 5 |
| TALC1 | 5 | 4 | 3 | 2 | 1 | |
| TALC2 | | 1 | 2 | 3 | 4 | 5 |
| ADD1 | 1 | 1 | 1 | 1 | 1 | 1 |
| COLOR1 | 2 | 2 | 2 | 2 | 2 | 2 |

TABLE 3B
Properties of Example 3 Materials

| | Properties of Example 3 Materials | | | | | |
|---|---|---|---|---|---|---|
| Property | EX3-A | EX3-B | EX3-C | EX3-D | EX3-E | EX3-F |
| MFR | 25.3 | 24.8 | 25.3 | 25.2 | 24.4 | 25.2 |
| TS | 19.2 | 18.8 | 18.8 | 18.8 | 19.1 | 18.6 |
| FM | 1181 | 1139 | 1167 | 1110 | 1099 | 1095 |
| RTNI | 51.5 | 51.8 | 50.2 | 51.4 | 51.3 | 51.5 |
| CTNI | 8.4 | 7.7 | 7.1 | 6.8 | 6.6 | 7.1 |
| GL | 82.9 | 82.2 | 81.6 | 81.5 | 80.9 | 80.6 |
| GRM | 85.7 | 87.9 | 90.6 | 91.1 | 91.3 | 92.2 |

### Example 4

Although important for property balance for some applications, high crystalline homopolymers or high crystalline homopolymer portions of copolymer polypropylene are not needed to impart high gloss. The formulations of three additional exemplary material compositions formed according to the principles of the present invention are summarized in Table 4A. General purpose copolymer (CPP3) and general purpose homopolymer (HPP1) are used in the following examples to give a high gloss appearance with a variety of elastomers. The properties of these exemplary compositions are summarized in Table 4B.

TABLE 4A
Composition of Materials Included in Example 4

| | Component Ratios for | | |
|---|---|---|---|
| | Example 4 Materials | | |
| Component | EX4-A | EX4-B | EX4-C |
| CPP3 | 17 | 27 | 32 |
| HPP1 | 58 | 48 | 43 |
| EOR1 | 20 | | |
| EOR3 | | 20 | |
| EBR1 | | | 20 |
| SEBS1 | 5 | 5 | 5 |
| ADD1 | 1 | 1 | 1 |

TABLE 4B
Properties of Example 4 Materials

| | Properties of | | |
|---|---|---|---|
| | Example 4 Materials | | |
| Property | EX4-A | EX4-B | EX4-C |
| MFR | 16.5 | 15.3 | 16.7 |
| TS | 22.1 | 22.4 | 21.7 |
| FM | 967 | 1008 | 1028 |
| RTNI | 40.0 | 36.6 | 33.1 |
| CTNI | 4.1 | 4.1 | 4.4 |
| II | 100 | 100 | 100 |
| GL | 84.4 | 84.3 | 85.8 |
| (w/2% Color 1) | | | |

### Example 5

Three additional material were prepared and formulated as set forth in Table 5A. High crystallinity polypropylene homopolymers can be used to give a high gloss appearance in a thermoplastic olefin compound. EX5-A and EX5-B demonstrate this effect in compounds with two different EOR. In addition, EX5-C demonstrates a 10% talc filled material that maintains a high surface gloss due to the low particle size of TALC3. The properties of these exemplary compositions are summarized in Table 5B.

TABLE 5A
Composition of Materials Included in Example 5

| | Component Ratios for | | |
|---|---|---|---|
| | Example 5 Materials | | |
| Component | EX5-A | EX5-B | EX5-C |
| HPP1 | 5 | | |
| HPP2 | 68 | 58 | 52 |
| HPP3 | | 15 | 13 |
| EOR1 | 20 | | 20 |
| EOR3 | | 20 | |
| SEBS1 | 5 | 5 | 5 |
| TALC3 | 2 | 2 | 10 |
| ADDS1 | 1 | 1 | 1 |

TABLE 5B
Properties of Example 5 Materials

| | Properties of | | |
|---|---|---|---|
| | Example 5 Materials | | |
| Property | EX5-A | EX5-B | EX5-C |
| MFR | 27.5 | 30.2 | 38.6 |
| TS | 23.9 | 24.8 | 23.8 |
| FM | 1374 | 1435 | 1829 |
| RTNI | 46.3 | 42.7 | 44.7 |
| CTNI | 4.3 | 4.4 | 3.9 |
| GL | 85.1 | 86.2 | 85.6 |
| (w/2% Color 1) | | | |

### Example 6

The five material compositions prepared according to this example were formulated as set forth in Table 6A. Polypropylene copolymers with high intrinsic viscosity ethylene-propylene portions (CPP1, CPP2) impart flow stability to compounds. Tiger striping during injection molding is one mark of flow instability. EX6-A, EX6-B, and EX6-C contained these copolymers at varying ratios and showed no evidence of tiger striping. Tiger striping became apparent when the content of CPP1 and CPP2 dropped to 15% in this example (EX6-D). Tiger striping is most severe on EX6-E with no CPP1 or CPP2. The properties of these compositions are summarized in Table 6B.

TABLE 6A
Composition of Materials Included in Example 6

| | Component Ratios for Example 6 Materials | | | | |
|---|---|---|---|---|---|
| Component | EX6-A | EX6-B | EX6-C | EX6-D | EX6-E (EX5-C) |
| CPP1 | 35 | 25 | 15 | 15 | |
| CPP2 | 30 | 20 | 15 | | |
| HPP2 | | 14 | 27 | 37 | 52 |
| HPP3 | | 6 | 8 | 13 | 13 |
| EOR1 | 20 | 20 | 20 | 20 | 20 |
| SEBS1 | 5 | 5 | 5 | 5 | 5 |
| TALC3 | 10 | 10 | 10 | 10 | 10 |
| ADDS1 | 1 | 1 | 1 | 1 | 1 |

TABLE 6B
Properties of Example 6 Materials

| | Properties of Example 6 Materials | | | | |
|---|---|---|---|---|---|
| Property | EX6-A | EX6-B | EX6-C | EX6-D | EX6-E (EX5-C) |
| MFR | 29.2 | 31.4 | 33.4 | 34.8 | 38.6 |
| FM | 1406 | 1492 | 1617 | 1634 | 1829 |
| RTNI | 52.8 | 50.7 | 47.3 | 45.0 | 44.7 |
| CTNI | 6.8 | 6.4 | 4.8 | 4.0 | 3.9 |
| TIG | 5 | 5 | 5 | 4 | 3 |
| GL | 84.9 | 84.8 | 85.1 | 85.5 | 85.6 |
| (w/ 2% | | | | | |
| COLOR1) | | | | | |

### Example 7

The following example demonstrates the accelerated weathering characteristics of particular embodiments of this invention. According to this example, for exemplary material compositions were formulated as set forth in Table 7A. The properties of these formulations are summarized in Table 7B. The weathering characteristics of these examples are also summarized in Table 7C.

TABLE 7A
Composition of Materials Included in Example 7

Component Ratios for
Example 7 Materials

| Component | EX7-A | EX7-B | EX7-C | EX7-D |
|---|---|---|---|---|
| CPP1 | 65 | 65 | 5 | 5 |
| CPP2 | | | 60 | 60 |
| EOR2 | 25 | 25 | | |
| SEBS1 | 5 | 5 | 30 | 30 |
| TALC1 | 5 | 5 | 5 | 5 |
| ADD2 | 1.3 | 1.3 | 1.3 | 1.3 |
| COLOR2 | 4 | | 4 | |
| COLOR3 | | 4 | | 4 |

TABLE 7B
Properties of Example 7 Materials

| | |
|---|---|
| Physical | Properties of Example 7 Materials |

| Property | EX7-A | EX7-B | EX7-C | EX7-D |
|---|---|---|---|---|
| MFR | 30.2 | 29.3 | 22.0 | 21.5 |
| TS | 21.3 | 22.7 | 18.2 | 17.9 |
| FM | 1140 | 1190 | 1066 | 1064 |
| RTNI | 33.1 | 29.6 | 59.9 | 59.6 |
| CTNI | 3.6 | 3.5 | 10.1 | 9.4 |
| II | 90 | 90 | 100 | 100 |
| GL | 86.3 | 80.9 | 83.8 | 79.2 |

TABLE 7C
Weathering Properties of Example 7 Materials
SAE J1976 Weathering Properties of Example 7 Materials

| | | Weathering Duration (hrs) | | | | | |
|---|---|---|---|---|---|---|---|
| | | 0 | 1001 | 2000 | 3000 | 4002 | 5000 |
| EX7-A | DE | — | 0.1 | 0.1 | 0.4 | 0.6 | 1.5 |
| | WEGL | 85.97 | 84.47 | 78.30 | 74.10 | 65.60 | 53.60 |
| EX7-B | DE | — | 0.1 | 0.1 | 0.1 | 0.2 | 0.6 |
| | WEGL | 79.63 | 80.90 | 77.70 | 75.10 | 78.40 | 78.27 |
| EX7-C | DE | — | 0.3 | 0.2 | 0.3 | 0.4 | 0.7 |
| | WEGL | 81.10 | 80.00 | 80.00 | 72.80 | 66.70 | 57.83 |
| EX7-D | DE | — | 0.1 | 0.1 | 0.1 | 0.0 | 0.5 |
| | WEGL | 79.97 | 79.33 | 76.70 | 79.60 | 71.10 | 69.13 |

All numbers expressing quantities or parameters used in the specification are to be understood as additionally being modified in all instances by the term “about.” Notwithstanding the numerical ranges and parameters set forth, the broad scope of the subject matter presented herein are approximations, the numerical values set forth are indicated as precisely as possible. For example, any numerical value may inherently contain certain errors resulting from inaccuracies in their respective measurement techniques, or round-off errors and other common inaccuracies.

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

We claim:

1. A compound comprising:
one or more polymer (A) selected from propylene-ethylene block copolymers (A1), propylene homopolymers (A2) and a combination of copolymers (A1) and/or homopolymers (A2), at 30% to 90% by weight;
one or more copolymer (B) selected from ethylene-alpha-olefin random copolymers (B1), hydrogenated styrene-ethylene-butadiene-styrene block copolymers (B2) and a combination of copolymers (B1) and/or copolymers (B2), at 0% to 50% by weight;
on or more mineral filler (C) at 0% to 30% by weight;
one or more surface modifier (D) at 0% to 5% by weight;
one or more additive (E) at 0% to 5% by weight; and
one or more colorant (F) at 0% to 10% by weight.

2. The compound of claim 1, wherein the one or more copolymers (B) comprise:
one or more ethylene-alpha-olefin random copolymer (B1) at 10 to 30% by weight; and
one or more hydrogenated styrene-ethylene-butadiene-styrene block copolymer (B2) at 1% to 20% by weight

3. The compound according to claim 1, wherein the at least one propylene-ethylene block copolymer (A1) has a melt flow rate of 0.7 g/10 min to the 200 g/10 min at 230° C. and 2.16 kg.

4. The compound according to claim 3, wherein the at least one propylene-ethylene block copolymer (A1) comprises high crystallinity polypropylene homopolymer portions and high intrinsic viscosity ethylene-propylene rubber portions.

5. The compound according to claim 1, wherein the at least one propylene homopolymer (A2) has a melt flow rate of <1 to 400 g/10 min at 230° C. and 2.16 kg.

6. The compound according to claim 1, wherein the at least one propylene homopolymer has a melt flow rate of 0.7 to 400 g/10 min and less than 1.5% by weight of xylene soluble portions.

7. The compound according to claim 1, wherein the at least one ethylene-alpha-olefin random copolymer (B1) comprises ethylene subunits and alpha-olefin subunits with between 3 and 10 carbons.

8. The compound according to claim 7, wherein the at least one ethylene-alpha-olefin random copolymer (B1) comprises ethylene-propylene random copolymers, ethylene-butene random copolymers, and/or ethylene-octene random copolymers that have a density of 0.86 to 0.91 g/cm³ in and a melt index of 0.1 to 30 g/10 min at 2.16 kg at 190° C.

9. The compound according to claim 8, wherein the at least one ethylene-octene random copolymer (B1) has a DSC melting temperature greater than 90° C.

10. The compound according to claim 1, wherein the at least one hydrogenated styrene-ethylene-butadiene-styrene block copolymer (B2) has styrene/ethylene-butadiene weight ratios of 18/82 to 67/33, with melt flow rates of 0.8 to 150 g/10 min at 230° C. and 2.16 kg.

11. The compound according to claim 1, wherein the at least one mineral filler (C) comprises talc, wollastonite, mica, nanoclays, and/or calcium carbonate with a median particle size no greater than 2 μm.

12. The compound according to claim 11, wherein the at least one mineral filler comprises a combination of talc with a median particle size less than 1 μm and different talc with median particle size greater than 1 μm and less than 2 μm.

13. The compound according to claim 1, wherein the at least one surface modifier (D) comprises quaternary ammonium, phosphonium, or sulfonium salts; sodium salts of sulfonates, phosphates, and carboxylic acids; fatty acid esters; ethoxylated tertiary amines; glycerol monostearate; fatty amides; fatty acid amides; natural and manufactured waxes; metallic salts of fatty acids; silica compounds; polyvinyl alcohol; polyamides; polyethylene; polysiloxanes; and/or fatty acids.

14. The compound according to claim 1, wherein the at least one additive (E) comprises primary antioxidants, secondary antioxidants, light stabilizers and/or processing aids.

15. The compound according to claim 1, wherein the at least one colorant (F) comprises a combination of inorganic pigments, organic pigments and/or metallic flakes.

16. A body formed from the compound of claim 1, the body having a gloss of 76 or greater at a 60° angle of incidence.

17. The body of claim 16, wherein the body has a gloss of at least 85 at a 60° angle of incidence.

18. A part of an automobile formed from the compound of claim 1.

19. A method of making a molded body, the method comprising:
melt blending the constituents (A), (B), (C), (D) and (E) of the compound of claim 1;
pelletizing the melt blend to form a plurality of pellets; and
injection molding the pelletized blend.

20. The method of claim 19, wherein the constituents are blended with a twin-screw extruders, a high-intensity continuous mixer, or a Banbury mixer.
